(19) United States
(12) Patent Application Publication
(10) Pub. No.: US 2014/0267757 A1
(43) Pub. Date: Sep. 18, 2014

(54) PARALLAX CORRECTION IN THERMAL IMAGING CAMERAS

(71) Applicant: Fluke Corporation, Everett, WA (US)

(72) Inventors: Jeffrey M. Abramson, Eden Prairie, MN (US); Jay Y. Choi, Seattle, WA (US); Ernest Y. Chan, Seattle, WA (US); Timothy J. Wheatley, Berkshire (GB); Mark N. Senior, Northamptonshire (GB)

(21) Appl. No.: 13/834,217

(22) Filed: Mar. 15, 2013

(51) Int. Cl. H04N 5/232; H04N 5/33

(52) U.S. Cl. CPC H04N 5/23216; H04N 5/33
USPC 348/164

(57) ABSTRACT

A method and apparatus for reducing parallax offset in a combination infrared and visible light camera. A thermal imaging camera comprises at least two modes of operation for correcting parallax offset, and is designed to shift at least one of the visible light and infrared images by a predetermined amount. The amount of the shift is dependent at least on the mode of operation. The mode of operation may be manually selected by the user via a user interface on the camera.

### BACKGROUND

Thermal imaging cameras are used in a variety of situations. For example, thermal imaging cameras are often used during maintenance inspections to thermally inspect equipment. Example equipment may include rotating machinery, electrical panels, or rows of circuit breakers, among other types of equipment. Thermal inspections can detect equipment hot spots such as overheating machinery or electrical components, helping to ensure timely repair or replacement of the overheating equipment before a more significant problem develops.

Depending on the configuration of the camera, the thermal imaging camera may also generate a visible light image of the same object. The camera may display the infrared image and the visible light image in a coordinated manner, for example, to help an operator interpret the thermal image generated by the thermal imaging camera. Unlike visible light images which generally provide good contrast between different objects, it is often difficult to recognize and distinguish different features in a thermal image as compared to the real-world scene. For this reason, an operator may rely on a visible light image to help interpret and focus the thermal image.

In applications where a thermal imaging camera is configured to generate both a thermal image and a visual light image, the camera may include two separate sets of optics: visible light optics that focus visible light on a visible light sensor for generating the visible light image, and infrared optics that focus infrared radiation on an infrared sensor for generating the infrared optics.

Cameras that comprise visible light optics and sensor as well as infrared optics and sensor may position these separate arrangements in separate locations on the camera. For example, the VL components may be located above, below, or to either side of the IR components. Accordingly, it is conceivable that, in some embodiments, the scene observed by the two sets of optics is substantially different, with one being offset from the other, that is, there may be a parallax offset incorporated between the images, which may be a manifestation of a registration error due to parallax from the two sets of optics. In some previous embodiments, a user may adjust the focus of one or more sets of optics in an effort to resolve this parallax offset. Other cameras, however, may be fixed-focus devices and may not have an adjustable focus with which to address the parallax offset.

### SUMMARY

Certain embodiments of the invention generally relate to methods and devices for reducing or eliminating parallax offset between infrared (IR) and visible light (VL) images in thermal imaging cameras. Often, cameras comprising both IR and VL optics cannot place both sets of optics in the same location. Thus, the VL and IR optics look at target scenes from at least a slightly different perspective. This may lead to a parallax offset in the resulting VL and IR images. Furthermore, the parallax offset may be different depending on the distance to the target being imaged. Thermal imaging cameras of the present invention comprise at least two modes of operation which are selectable by the user, and, when switching from one mode to the other, shift at least one of the VL and IR images by some predetermined amount. This shift is aimed at reducing the parallax offset between the VL and IR images.

Since the parallax offset may be dependent on the distance to the target, the camera may comprise near and far modes of operation, each preferable over a different range of target distances. For example, the near mode of operation may result in minimal parallax offset when the target distance is less than about 6 inches away. Further away than this, and far mode may result in less parallax offset.

Thermal imaging cameras may display VL and IR images relative to one another in several ways, including one within the other, the two images combine in a composite image, one overlayed on the other, and the like. Imagers of the present invention may display images in any of these arrangements, and may shift either the VL or IR image relative to the other. The amount of relative shifting between the images when switching between modes may be fixed at all times, may depend on the relative sizes of the images or alternatively may depend on other factors such as a distance to target.

The user may change modes of the camera in response to visually observing a parallax offset or by estimating the distance to the target scene and predicting the preferred mode of operation. Alternatively, the camera may detect the distance to the target and suggest a mode of operation. The user may select the mode by several means, including a push button, touch screen, switch, and voice command.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a perspective front view of an example thermal imaging camera.

FIG. 2 is a perspective back view of the example thermal imaging camera of FIG. 1.

FIG. 3 is a functional block diagram illustrating example components of the thermal imaging camera of FIGS. 1 and 2.

FIG. 4 is a user-interactive portion of certain embodiments of the invention.

FIG. 5a is a side view of a camera capturing both an infrared and visible light image of a target scene in certain modes of operation.

FIG. 5b is a side view of a camera capturing both an infrared and visible light image of a target scene in certain modes of operation.

FIG. 6 illustrates a process-flow diagram depicting the switching of the imager from far-mode to near-mode imaging to reduce parallax offset, according to certain embodiments of the invention.

FIG. 7 illustrates a process-flow diagram showing the switching of the imager from near-mode to far-mode imaging to reduce parallax offset, according to certain embodiments of the invention.

FIG. 8 shows an example combination visible light and infrared image with a parallax offset.

### DETAILED DESCRIPTION

The following detailed description is exemplary in nature and is not intended to limit the scope, applicability, or configuration of the invention in any way. Rather, the following description provides some practical illustrations for implementing examples of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

A thermal imaging camera may be used to detect heat patterns across a scene under observation. The thermal imaging camera may detect infrared radiation given off by the scene and convert the infrared radiation into an infrared image indicative of the heat patterns. In some examples, the thermal imaging camera may also capture visible light from the scene and convert the visible light into a visible light image. Depending on the configuration of the thermal imaging camera, the camera may include infrared optics to focus the infrared radiation on an infrared sensor and visible light optics to focus the visible light on a visible light sensor.

FIGS. 1 and 2 show front and back perspective views, respectively of an example thermal imaging camera 100, which includes a housing 102, an infrared lens assembly 104, a visible light lens assembly 106, a display 108, a laser 110, and a trigger control 112. Housing 102 houses the various components of thermal imaging camera 100. The bottom portion of thermal imaging camera 100 includes a carrying handle for holding and operating the camera via one hand. Infrared lens assembly 104 receives infrared radiation from a scene and focuses the radiation on an infrared sensor for generating an infrared image of a scene. Visible light lens assembly 106 receives visible light from a scene and focuses the visible light on a visible light sensor for generating a visible light image of the same scene. Thermal imaging camera 100 captures the visible light image and/or the infrared image in response to depressing trigger control 112. In addition, thermal imaging camera 100 controls display 108 to display the infrared image and the visible light image generated by the camera, e.g., to help an operator thermally inspect a scene. Thermal imaging camera 100 may also include a focus mechanism coupled to infrared lens assembly 104 that is configured to move at least one lens of the infrared lens assembly so as to adjust the focus of an infrared image generated by the thermal imaging camera.

In operation, thermal imaging camera 100 detects heat patterns in a scene by receiving energy emitted in the infrared-wavelength spectrum from the scene and processing the infrared energy to generate a thermal image. Thermal imaging camera 100 may also generate a visible light image of the same scene by receiving energy in the visible light-wavelength spectrum and processing the visible light energy to generate a visible light image. As described in greater detail below, thermal imaging camera 100 may include an infrared camera module that is configured to capture an infrared image of the scene and a visible light camera module that is configured to capture a visible light image of the same scene. The infrared camera module may receive infrared radiation projected through infrared lens assembly 104 and generate therefrom infrared image data. The visible light camera module may receive light projected through visible light lens assembly 106 and generate therefrom visible light data.

In some examples, thermal imaging camera 100 collects or captures the infrared energy and visible light energy substantially simultaneously (e.g., at the same time) so that the visible light image and the infrared image generated by the camera are of the same scene at substantially the same time. In these examples, the infrared image generated by thermal imaging camera 100 is indicative of localized temperatures within the scene at a particular period of time while the visible light image generated by the camera is indicative of the same scene at the same period of time. In other examples, thermal imaging camera may capture infrared energy and visible light energy from a scene at different periods of time.

Visible light lens assembly 106 includes at least one lens that focuses visible light energy on a visible light sensor for generating a visible light image. Visible light lens assembly 106 defines a visible light optical axis which passes through the center of curvature of the at least one lens of the assembly. Visible light energy projects through a front of the lens and focuses on an opposite side of the lens. Visible light lens assembly 106 can include a single lens or a plurality of lenses (e.g., two, three, or more lenses) arranged in series. In addition, visible light lens assembly 106 can have a fixed focus or can include a focus adjustment mechanism for changing the focus of the visible light optics. In examples in which visible light lens assembly 106 includes a focus adjustment mechanism, the focus adjustment mechanism may be a manual adjustment mechanism or an automatic adjustment mechanism.

Infrared lens assembly 104 also includes at least one lens that focuses infrared energy on an infrared sensor for generating a thermal image. Infrared lens assembly 104 defines an infrared optical axis which passes through the center of curvature of lens of the assembly. During operation, infrared energy is directed through the front of the lens and focused on an opposite side of the lens. Infrared lens assembly 104 can include a single lens or a plurality of lenses (e.g., two, three, or more lenses), which may be arranged in series.

As briefly described above, thermal imaging camera 100 includes a focus mechanism for adjusting the focus of an infrared image captured by the camera. In the example shown in FIGS. 1 and 2, thermal imaging camera 100 includes focus ring 114. Focus ring 114 is operatively coupled (e.g., mechanically and/or electrically coupled) to at least one lens of infrared lens assembly 104 and configured to move the at least one lens to various focus positions so as to focus the infrared image captured by thermal imaging camera 100. Focus ring 114 may be manually rotated about at least a portion of housing 102 so as to move the at least one lens to which the focus ring is operatively coupled. In some examples, focus ring 114 is also operatively coupled to display 108 such that rotation of focus ring 114 causes at least a portion of a visible light image and at least a portion of an infrared image concurrently displayed on display 108 to move relative to one another. In different examples, thermal imaging camera 100 may include a manual focus adjustment mechanism that is implemented in a configuration other than focus ring 114.

In some examples, thermal imaging camera 100 may include an automatically adjusting focus mechanism in addition to or in lieu of a manually adjusting focus mechanism. An automatically adjusting focus mechanism may be operatively coupled to at least one lens of infrared lens assembly 104 and configured to automatically move the at least one lens to various focus positions, e.g., in response to instructions from thermal imaging camera 100. In one application of such an example, thermal imaging camera 100 may use laser 110 to electronically measure a distance between an object in a target scene and the camera, referred to as the distance-to-target. Thermal imaging camera 100 may then control the automatically adjusting focus mechanism to move the at least one lens of infrared lens assembly 104 to a focus position that corresponds to the distance-to-target data determined by thermal imaging camera 100. The focus position may correspond to the distance-to-target data in that the focus position may be configured to place the object in the target scene at the determined distance in focus. In some examples, the focus position set by the automatically adjusting focus mechanism may be manually overridden by an operator, e.g., by rotating focus ring 114.

Data of the distance-to-target, as measured by the laser 110, can be stored and associated with the corresponding captured image. For images which are captured using automatic focus, this data will be gathered as part of the focusing process. In some embodiments, the thermal imaging camera will also detect and save the distance-to-target data when an image is captured. This data may be obtained by the thermal imaging camera when the image is captured by using the laser 110 or, alternatively, by detecting the lens position and correlating the lens position to a known distance-to-target associated with that lens position. The distance-to-target data may be used by the thermal imaging camera 100 to direct the user to position the camera at the same distance from the target, such as by directing a user to move closer or further from the target based on laser measurements taken as the user repositions the camera, until the same distance-to-target is achieved as in an earlier image. The thermal imaging camera may further automatically set the lenses to the same positions as used in the earlier image, or may direct the user to reposition the lenses until the original lens settings are obtained.

During operation of thermal imaging camera 100, an operator may wish to view a thermal image of a scene and/or a visible light image of the same scene generated by the camera. For this reason, thermal imaging camera 100 may include a display. In the examples of FIGS. 1 and 2, thermal imaging camera 100 includes display 108, which is located on the back of housing 102 opposite infrared lens assembly 104 and visible light lens assembly 106. Display 108 may be configured to display a visible light image, an infrared image, and/or a composite image that is a simultaneous display of the visible light image and the infrared image. In different examples, display 108 may be remote (e.g., separate) from infrared lens assembly 104 and visible light lens assembly 106 of thermal imaging camera 100, or display 108 may be in a different spatial arrangement relative to infrared lens assembly 104 and/or visible light lens assembly 106. Therefore, although display 108 is shown behind infrared lens assembly 104 and visible light lens assembly 106 in FIG. 2, other locations for display 108 are possible.

Thermal imaging camera 100 can include a variety of user input media for controlling the operation of the camera and adjusting different settings of the camera. Example control functions may include adjusting the focus of the infrared and/or visible light optics, opening/closing a shutter, capturing an infrared and/or visible light image, or the like. In the example of FIGS. 1 and 2, thermal imaging camera 100 includes a depressible trigger control 112 for capturing an infrared and visible light image, and buttons 116, which form part of the user interface, for controlling other aspects of the operation of the camera. A different number or arrangement of user input media are possible, and it should be appreciated that the disclosure is not limited in this respect. For example, thermal imaging camera 100 may include a touch screen display 108 which receives user input by depressing different portions of the screen.

FIG. 3 is a functional block diagram illustrating components of an example of thermal imaging camera 100. Thermal imaging camera 100 includes an IR camera module 200, front end circuitry 202. The IR camera module 200 and front end circuitry 202 are sometimes referred to in combination as front end stage or front end components 204 of the infrared camera 100. Thermal imaging camera 100 may also include a visible light camera module 206, a display 108, a user interface 208, and an output/control device 210.

Infrared camera module 200 may be configured to receive infrared energy emitted by a target scene and to focus the infrared energy on an infrared sensor for generation of infrared energy data, e.g., that can be displayed in the form of an infrared image on display 108 and/or stored in memory. Infrared camera module 200 can include any suitable components for performing the functions attributed to the module herein. In the example of FIG. 3, infrared camera module 200 is illustrated as including infrared lens assembly 104 and infrared sensor 220. As described above with respect to FIGS. 1 and 2, infrared lens assembly 104 includes at least one lens that takes infrared energy emitted by a target scene and focuses the infrared energy on infrared sensor 220. Infrared sensor 220 responds to the focused infrared energy by generating an electrical signal that can be converted and displayed as an infrared image on display 108.

Infrared lens assembly 104 can have a variety of different configurations. In some examples, infrared lens assembly 104 defines an F-number (which may also be referred to as a focal ratio or F-stop) of a specific magnitude. An approximate F-number may be determined by dividing the effective focal length of a lens assembly by a diameter of an entrance to the lens assembly (e.g., an outermost lens of infrared lens assembly 104), which may be indicative of the amount of infrared radiation entering the lens assembly. In general, increasing the F-number of infrared lens assembly 104 may increase the depth-of-field, or distance between nearest and farthest objects in a target scene that are in acceptable focus, of the lens assembly. An increased depth of field may help achieve acceptable focus when viewing different objects in a target scene with the infrared optics of thermal imaging camera 100 set at a hyperfocal position. If the F-number of infrared lens assembly 104 is increased too much, however, the diffraction effects will decrease spatial resolution (e.g., clarity) such that a target scene may not be in acceptable focus. An increased F-number may also reduce the thermal sensitivity (e.g., the noise-equivalent temperature difference will worsen).

Infrared sensor 220 may include one or more focal plane arrays (FPA) that generate electrical signals in response to infrared energy received through infrared lens assembly 104. Each FPA can include a plurality of infrared sensor elements including, e.g., bolometers, photon detectors, or other suitable infrared sensor elements. In operation, each sensor element, which may each be referred to as a sensor pixel, may change an electrical characteristic (e.g., voltage or resistance) in response to absorbing infrared energy received from a target scene. In turn, the change in electrical characteristic can provide an electrical signal that can be received by a processor 222 and processed into an infrared image displayed on display 108.

For instance, in examples in which infrared sensor 220 includes a plurality of bolometers, each bolometer may absorb infrared energy focused through infrared lens assembly 104 and increase in temperature in response to the absorbed energy. The electrical resistance of each bolometer may change as the temperature of the bolometer changes. With each detector element functioning as a pixel, a two-dimensional image or picture representation of the infrared radiation can be further generated by translating the changes in resistance of each detector element into a time-multiplexed electrical signal that can be processed for visualization on a display or storage in memory (e.g., of a computer). Processor 222 may measure the change in resistance of each bolometer by applying a current (or voltage) to each bolometer and measure the resulting voltage (or current) across the bolometer. Based on these data, processor 222 can determine the amount of infrared energy emitted by different portions of a target scene and control display 108 to display a thermal image of the target scene.

Independent of the specific type of infrared sensor elements included in the FPA of infrared sensor 220, the FPA array can define any suitable size and shape. In some examples, infrared sensor 220 includes a plurality of infrared sensor elements arranged in a grid pattern such as, e.g., an array of sensor elements arranged in vertical columns and horizontal rows. In various examples, infrared sensor 220 may include an array of vertical columns by horizontal rows of, e.g., 16×16, 50×50, 160×120, 120×160 or 640×480. In other examples, infrared sensor 220 may include a smaller number of vertical columns and horizontal rows (e.g., 1×1), a larger number vertical columns and horizontal rows (e.g., 1000×1000), or a different ratio of columns to rows.

In certain embodiments a Read Out Integrated Circuit (ROIC) is incorporated on the IR sensor 220. The ROIC is used to output signals corresponding to each of the pixels. Such ROIC is commonly fabricated as an integrated circuit on a silicon substrate. The plurality of detector elements may be fabricated on top of the ROIC, wherein their combination provides for the IR sensor 220. In some embodiments, the ROIC can include components discussed elsewhere in this disclosure (e.g. an analog-to-digital converter (ADC)) incorporated directly onto the FPA circuitry. Such integration of the ROIC, or other further levels of integration not explicitly discussed, should be considered within the scope of this disclosure.

As described above, the IR sensor 220 generates a series of electrical signals corresponding to the infrared radiation received by each infrared detector element to represent a thermal image. A “frame” of thermal image data is generated when the voltage signal from each infrared detector element is obtained by scanning all of the rows that make up the IR sensor 220. Again, in certain embodiments involving bolometers as the infrared detector elements, such scanning is done by switching a corresponding detector element into the system circuit and applying a bias voltage across such switched-in element. Successive frames of thermal image data are generated by repeatedly scanning the rows of the IR sensor 220, with such frames being produced at a rate sufficient to generate a video representation (e.g. 30 Hz, or 60 Hz) of the thermal image data.

The front end circuitry 202 includes circuitry for interfacing with and controlling the IR camera module 200. In addition, the front end circuitry 202 initially processes and transmits collected infrared image data to a processor 222 via a connection therebetween. More specifically, the signals generated by the IR sensor 220 are initially conditioned by the front end circuitry 202 of the thermal imaging camera 100. In certain embodiments, as shown, the front end circuitry 202 includes a bias generator 224 and a pre-amp/integrator 226. In addition to providing the detector bias, the bias generator 224 can optionally add or subtract an average bias current from the total current generated for each switched-in detector element. The average bias current can be changed in order (i) to compensate for deviations to the entire array of resistances of the detector elements resulting from changes in ambient temperatures inside the thermal imaging camera 100 and (ii) to compensate for array-to-array variations in the average detector elements of the IR sensor 220. Such bias compensation can be automatically controlled by the thermal imaging camera 100 or software, or can be user controlled via input to the output/control device 210 or processor 222. Following provision of the detector bias and optional subtraction or addition of the average bias current, the signals can be passed through a pre-amp/integrator 226. Typically, the pre-amp/integrator 226 is used to condition incoming signals, e.g., prior to their digitization. As a result, the incoming signals can be adjusted to a form that enables more effective interpretation of the signals, and in turn, can lead to more effective resolution of the created image. Subsequently, the conditioned signals are sent downstream into the processor 222 of the thermal imaging camera 100.

In some embodiments, the front end circuitry 202 can include one or more additional elements for example, additional sensors 228 or an ADC 230. Additional sensors 228 can include, for example, temperature sensors, visual light sensors (such as a CCD), pressure sensors, magnetic sensors, etc. Such sensors can provide additional calibration and detection information to enhance the functionality of the thermal imaging camera 100. For example, temperature sensors can provide an ambient temperature reading near the IR sensor 220 to assist in radiometry calculations. A magnetic sensor, such as a Hall effect sensor, can be used in combination with a magnet mounted on the lens to provide lens focus position information. Such information can be useful for calculating distances, or determining a parallax offset for use with visual light scene data gathered from a visual light sensor.

An ADC 230 can provide the same function and operate in substantially the same manner as discussed below, however its inclusion in the front end circuitry 202 may provide certain benefits, for example, digitization of scene and other sensor information prior to transmittal to the processor 222 via the connection therebetween. In some embodiments, the ADC 230 can be integrated into the ROIC, as discussed above, thereby eliminating the need for a separately mounted and installed ADC 230.

In some embodiments, front end components can further include a shutter 240. A shutter 240 can be externally or internally located relative to the lens and operate to open or close the view provided by the IR lens assembly 104. As is known in the art, the shutter 240 can be mechanically positionable, or can be actuated by an electro-mechanical device such as a DC motor or solenoid. Embodiments of the invention may include a calibration or setup software implemented method or setting which utilize the shutter 240 to establish appropriate bias levels for each detector element.

Components described as processors within thermal imaging camera 100, including processor 222, may be implemented as one or more processors, such as one or more microprocessors, digital signal processors (DSPs), application specific integrated circuits (ASICs), field programmable gate arrays (FPGAs), programmable logic circuitry, or the like, either alone or in any suitable combination. Processor 222 may also include memory that stores program instructions and related data that, when executed by processor 222, cause thermal imaging camera 100 and processor 222 to perform the functions attributed to them in this disclosure. Memory may include any fixed or removable magnetic, optical, or electrical media, such as RAM, ROM, CD-ROM, hard or floppy magnetic disks, EEPROM, or the like. Memory may also include a removable memory portion that may be used to provide memory updates or increases in memory capacities. A removable memory may also allow image data to be easily transferred to another computing device, or to be removed before thermal imaging camera 100 is used in another application. Processor 222 may also be implemented as a System on Chip that integrates all components of a computer or other electronic system into a single chip. These elements manipulate the conditioned scene image data delivered from the front end stages 204 in order to provide output scene data that can be displayed or stored for use by the user. Subsequently, the processor 222 (processing circuitry) sends the processed data to a display 108 or other output/control device 210.

During operation of thermal imaging camera 100, processor 222 can control infrared camera module 200 to generate infrared image data for creating an infrared image. Processor 222 can generate a digital “frame” of infrared image data. By generating a frame of infrared image data, processor 222 captures an infrared image of a target scene at a given point in time.

Processor 222 can capture a single infrared image or “snap shot” of a target scene by measuring the electrical signal of each infrared sensor element included in the FPA of infrared sensor 220 a single time. Alternatively, processor 222 can capture a plurality of infrared images of a target scene by repeatedly measuring the electrical signal of each infrared sensor element included in the FPA of infrared sensor 220. In examples in which processor 222 repeatedly measures the electrical signal of each infrared sensor element included in the FPA of infrared sensor 220, processor 222 may generate a dynamic thermal image (e.g., a video representation) of a target scene. For example, processor 222 may measure the electrical signal of each infrared sensor element included in the FPA at a rate sufficient to generate a video representation of thermal image data such as, e.g., 30 Hz or 60 Hz. Processor 222 may perform other operations in capturing an infrared image such as sequentially actuating a shutter 240 to open and close an aperture of infrared lens assembly 104, or the like.

With each sensor element of infrared sensor 220 functioning as a sensor pixel, processor 222 can generate a two-dimensional image or picture representation of the infrared radiation from a target scene by translating changes in an electrical characteristic (e.g., resistance) of each sensor element into a time-multiplexed electrical signal that can be processed, e.g., for visualization on display 108 and/or storage in memory. Processor 222 may perform computations to convert raw infrared image data into scene temperatures (radiometry) including, in some examples, colors corresponding to the scene temperatures.

Processor 222 may control display 108 to display at least a portion of an infrared image of a captured target scene. In some examples, processor 222 controls display 108 so that the electrical response of each sensor element of infrared sensor 220 is associated with a single pixel on display 108. In other examples, processor 222 may increase or decrease the resolution of an infrared image so that there are more or fewer pixels displayed on display 108 than there are sensor elements in infrared sensor 220. Processor 222 may control display 108 to display an entire infrared image (e.g., all portions of a target scene captured by thermal imaging camera 100) or less than an entire infrared image (e.g., a lesser port of the entire target scene captured by thermal imaging camera 100). Processor 222 may perform other image processing functions, as described in greater detail below.

Independent of the specific circuitry, thermal imaging camera 100 may be configured to manipulate data representative of a target scene so as to provide an output that can be displayed, stored, transmitted, or otherwise utilized by a user.

Thermal imaging camera 100 includes visible light camera module 206. Visible light camera module 206 may be configured to receive visible light energy from a target scene and to focus the visible light energy on a visible light sensor for generation of visible light energy data, e.g., that can be displayed in the form of a visible light image on display 108 and/or stored in memory. Visible light camera module 206 can include any suitable components for performing the functions attributed to the module herein. In the example of FIG. 3, visible light camera module 206 is illustrated as including visible light lens assembly 106 and visible light sensor 242. As described above with respect to FIGS. 1 and 2, visible light lens assembly 106 includes at least one lens that takes visible light energy emitted by a target scene and focuses the visible light energy on visible light sensor 242. Visible light sensor 242 responds to the focused energy by generating an electrical signal that can be converted and displayed as a visible light image on display 108.

Visible light sensor 242 may include a plurality of visible light sensor elements such as, e.g., CMOS detectors, CCD detectors, PIN diodes, avalanche photo diodes, or the like. The number of visible light sensor elements may be the same as or different than the number of infrared light sensor elements.

In operation, optical energy received from a target scene may pass through visible light lens assembly 106 and be focused on visible light sensor 242. When the optical energy impinges upon the visible light sensor elements of visible light sensor 242, photons within the photodetectors may be released and converted into a detection current. Processor 222 can process this detection current to form a visible light image of the target scene.

During use of thermal imaging camera 100, processor 222 can control visible light camera module 206 to generate visible light data from a captured target scene for creating a visible light image. The visible light data may include luminosity data indicative of the color(s) associated with different portions of the captured target scene and/or the magnitude of light associated with different portions of the captured target scene. Processor 222 can generate a “frame” of visible light image data by measuring the response of each visible light sensor element of thermal imaging camera 100 a single time. By generating a frame of visible light data, processor 222 captures visible light image of a target scene at a given point in time. Processor 222 may also repeatedly measure the response of each visible light sensor element of thermal imaging camera 100 so as to generate a dynamic thermal image (e.g., a video representation) of a target scene, as described above with respect to infrared camera module 200.

With each sensor element of visible light camera module 206 functioning as a sensor pixel, processor 222 can generate a two-dimensional image or picture representation of the visible light from a target scene by translating an electrical response of each sensor element into a time-multiplexed electrical signal that can be processed, e.g., for visualization on display 108 and/or storage in memory.

Processor 222 may control display 108 to display at least a portion of a visible light image of a captured target scene. In some examples, processor 222 controls display 108 so that the electrical response of each sensor element of visible light camera module 206 is associated with a single pixel on display 108. In other examples, processor 222 may increase or decrease the resolution of a visible light image so that there are more or fewer pixels displayed on display 108 than there are sensor elements in visible light camera module 206. Processor 222 may control display 108 to display an entire visible light image (e.g., all portions of a target scene captured by thermal imaging camera 100) or less than an entire visible light image (e.g., a lesser port of the entire target scene captured by thermal imaging camera 100).

As noted above, processor 222 may be configured to determine a distance between thermal imaging camera 100 and an object in a target scene captured by a visible light image and/or infrared image generated by the camera. Processor 222 may determine the distance based on a focus position of the infrared optics associated with the camera. For example, processor 222 may detect a position (e.g., a physical position) of a focus mechanism associated with the infrared optics of the camera (e.g., a focus position associated with the infrared optics) and determine a distance-to-target value associated with the position. Processor 222 may then reference data stored in memory that associates different positions with different distance-to-target values to determine a specific distance between thermal imaging camera 100 and the object in the target scene.

In these and other examples, processor 222 may control display 108 to concurrently display at least a portion of the visible light image captured by thermal imaging camera 100 and at least a portion of the infrared image captured by thermal imaging camera 100. Such a concurrent display may be useful in that an operator may reference the features displayed in the visible light image to help understand the features concurrently displayed in the infrared image, as the operator may more easily recognize and distinguish different real-world features in the visible light image than the infrared image. In various examples, processor 222 may control display 108 to display the visible light image and the infrared image in side-by-side arrangement, in a picture-in-picture arrangement, where one of the images surrounds the other of the images, or any other suitable arrangement where the visible light and the infrared image are concurrently displayed.

For example, processor 222 may control display 108 to display the visible light image and the infrared image in a composite arrangement. In a composite arrangement, the visible light image and the infrared image may be superimposed on top of one another. An operator may interact with user interface 208 to control the transparency or opaqueness of one or both of the images displayed on display 108. For example, the operator may interact with user interface 208 to adjust the infrared image between being completely transparent and completely opaque and also adjust the visible light image between being completely transparent and completely opaque. Such an example composite arrangement, which may be referred to as an alpha-blended arrangement, may allow an operator to adjust display 108 to display an infrared-only image, a visible light-only image, of any overlapping combination of the two images between the extremes of an infrared-only image and a visible light-only image. Processor 222 may also combine scene information with other data, such as radiometric data, alarm data, and the like.

Additionally, in some embodiments, the processor 222 can interpret and execute commands from user interface 208, an output/control device 210. This can involve processing of various input signals and transferring those signals to the front end circuitry 202 via a connection therebetween. Components (e.g. motors, or solenoids) proximate the front end circuitry 202 can be actuated to accomplish the desired control function. Exemplary control functions can include adjusting the focus, opening/closing a shutter, triggering sensor readings, adjusting bias values, etc. Moreover, input signals may be used to alter the processing of the image data that occurs in the processor 222.

Processor can further include other components to assist with the processing and control of the infrared imaging camera 100. For example, as discussed above, in some embodiments, an ADC can be incorporated into the processor 222. In such a case, analog signals conditioned by the front-end stages 204 are not digitized until reaching the processor 222. Moreover, some embodiments can include additional on board memory for storage of processing command information and scene data, prior to transmission to the display 108 or the output/control device 210.

An operator may interact with thermal imaging camera 100 via user interface 208, which may include buttons, keys, or another mechanism for receiving input from a user, such as a touch screen, a switch, or a microphone for receiving voice commands. The operator may receive output from thermal imaging camera 100 via display 108. Display 108 may be configured to display an infrared-image and/or a visible light image in any acceptable palette, or color scheme, and the palette may vary, e.g., in response to user control. In some examples, display 108 is configured to display an infrared image in a monochromatic palette such as grayscale or amber. In other examples, display 108 is configured to display an infrared image in a color palette such as, e.g., ironbow, blue-red, or other high contrast color scheme. Combination of grayscale and color palette displays are also contemplated.

While processor 222 can control display 108 to concurrently display at least a portion of an infrared image and at least a portion of a visible light image in any suitable arrangement, a picture-in-picture arrangement may help an operator to easily focus and/or interpret a thermal image by displaying a corresponding visible image of the same scene in adjacent alignment.

A power supply (not shown) delivers operating power to the various components of thermal imaging camera 100 and, in some examples, may include a rechargeable or non-rechargeable battery and a power generation circuit.

During operation of thermal imaging camera 100, processor 222 controls infrared camera module 200 and visible light camera module 206 with the aid of instructions associated with program information that is stored in memory to generate a visible light image and an infrared image of a target scene. Processor 222 further controls display 108 to display the visible light image and/or the infrared image generated by thermal imaging camera 100.

As previously mentioned, cameras comprising both IR and VL optics may experience parallax offset between associated IR and VL images. Parallax offsets may particularly arise when viewing scenes relatively close the camera, since parallax offset is likely more pronounced at close distances to the target. Some combination IR and VL imagers may have fixed focus optics, such that the focus positions of the optics are not adjustable on either the IR optics or the VL optics. In such fixed focus IR and VL cameras, the IR and VL optics may be adapted so that they capture substantially the same scene while viewing a far-away target, thus resulting in parallax offset while viewing scenes at near distances. Such “near distances” may comprise distance-to-target values of less than six inches, wherein below that threshold, associated IR and VL images may comprise substantial (e.g., objectionable to the user) parallax offset while operating the camera in a traditional configuration. Such an offset, for example, would cause combination VL and IR images as described above to appear misaligned and inaccurate, as shown in FIG. 8, for example.

Certain embodiments of the invention, involve a fixed focus, combination IR and VL camera that includes alternative modes of operation for near and far target distances, wherein the camera shifts at least one of the VL and IR images relative to the other by a predetermined amount to attempt to correct the offset. A predetermined amount refers to a “one time” adjustment, wherein the user does not further manipulate the amount of shifting incorporated into the images; however, the predetermined amount may be based upon measured or entered parameters. Such alternative modes of operation may comprise a “near-mode” and a “far-mode” of operation, corresponding to the distance between the target and the camera. Thus, when the distance-to-target is less than or equal to about six inches, near-mode operation may be preferable. Preferable, here, is taken to mean that, when the distance-to-target is less than, for instance, six inches, there will be less parallax offset while viewing the scene in near-mode when compared to viewing the scene in far-mode. When the distance to target is greater than this, it may be preferable to operate in the far-mode configuration.

According to some embodiments of the invention, the camera may be adjusted by a user into near-mode configuration in order to adjust or correct for this parallax offset. FIG. 4 shows a user-interactive portion of an embodiment of the invention. The embodiment shown in FIG. 4 comprises a display 108 and a user interface 208, including buttons 116, such as a near button 416a and a far button 416b. The near button 416a may be utilized by the user to place the camera into near-mode operation, while the far button 416b may be utilized to place the camera into far-mode operation. A portion of the display 108, the mode display 430 shown in the top left corner in the illustrated embodiment, may indicate to the user which mode of operation the camera is operating in. In FIG. 4, the mode display 430 indicates that the camera is operating in near-mode. In certain embodiments, the user interface 208 may only have a single button that the user pushes to toggle the mode of operation between near mode and far mode. Such button could be of any type, including a momentary button or a toggle switch. In such embodiments, the camera may use one mode as the default, e.g., the far mode, and the user may then toggle from the default mode to the other mode via actuation of the single button. In some embodiments, the camera 100 may employ an electronic range finder to determine the distance to target. In such embodiments, the processor in the camera 100 may automatically decide whether to switch to the near mode or the far mode. Use of the range finder could be user-initiated via a manual input via a user interface or it could be an automatic (e.g., periodic) measurement.

FIGS. 5a and 5b show a side view of the camera 100 capturing both an infrared (IR) 504 and visible light (VL) 506 image of a target scene 550 in various modes of operation. FIG. 5a shows the camera 100 capturing images from a first distance 552 away from the target whereas FIG. 5b shows the camera 100 capturing images from a second distance 554 away from the target 550. In certain embodiments, the first distance 552 may be such that the user may choose to enable near-mode operation to reduce parallax offsets between the VL 506 and IR 504 images. Doing so effectively causes the VL 506 and IR 504 images to be of substantially the same scene, as illustrated by the VL 506 and IR 504 cones, which show the area of the target each imaging assembly is capturing. Thus, a combination VL and IR image as previously described may be accurately constructed by the camera for saving and/or display.

FIG. 5b is similar to FIG. 5a, however it illustrates the use of the camera 100 to capture a VL 506 and an IR 504 image of a scene from a second distance 554 away, the second distance 554 being further than the first 552. In this situation, it may be beneficial to use the camera 100 in far-mode to allow the VL 506 and IR 504 images to be of substantially the same scene, allowing this to naturally occur because of the sufficiently large second distance 554 the target is from the camera. If the camera 100 were in near-mode operation, it is possible that the parallax adjustment used to correct offsets of short distance-to-target measurements (such as a measurement from the first distance 552 in FIG. 5a) could induce previously absent parallax offsets. Therefore, it is important to disable near-mode operation (e.g., operate in far mode) when targeting a scene that is outside the operable range of the near-mode corrections (such as the second distance 554 in FIG. 5b).

FIG. 6 illustrates a process-flow diagram depicting the switching of the imager from far-mode to near-mode imaging to reduce parallax offset. A thermal imager is operating 670 in far-mode while displaying at least portions of an IR image and an associated VL image of a scene. The far mode may be the default mode of operation that is employed upon initial start-up or power-up of the camera 100. During operation, a user may determine 672 if near-mode is appropriate for the scene to be imaged. This determination may be made based upon, among other things, the distance between the imager and the target scene to be imaged or an observed parallax offset on the display or any captured imagery. As noted above, the processor may employ a range finder to determine if the target is within the distance where near mode is preferable. If it is determined that near-mode is not appropriate, then the user resumes 674 operating the imager in far-mode. If it is determined to be appropriate, however, the user may instruct 676 the imager to switch to near-mode via the user interface.

Upon instruction, the processor in the imager receives 678 a signal from the user requesting near-mode operation. In certain embodiments, the processor may determine from a range finder input that near-mode operation is appropriate. In either embodiment, the processor proceeds to shift at least one of the IR and VL images a predetermined amount in an effort to correct or reduce the parallax offset. The predetermined amount may be based upon the size of one of the VL or IR images, wherein the shifted image(s) is/are shifted by a percentage of the image size. Alternatively, the predetermined amount may be based upon a determination of the estimated distance to the target scene. In additional embodiments, as noted above, the thermal imaging camera may utilize a range finder by which the camera may measure the distance to the target scene. In such embodiments, the predetermined shift may be based upon this measurement. Furthermore, the camera may use the distance-to-target data to prompt (e.g., visually via the display, audibly, etc.) the user to switch modes of operation. In some embodiments of the invention, the processor shifts the VL image while leaving the IR image stationary. In other embodiments, the VL image remains stationary while the IR image is shifted. In even further embodiments, both the IR and VL images are shifted to correct for the parallax offset.

Finally, the imager displays 680 at least portions of both the IR and VL images including any shift that has been implemented by the processor. Resultantly, the at least portions of IR and VL images displayed should have a lesser amount of parallax offset than if the camera were operating in far-mode. This will not be the case, however, if the imager is imaging a target that is substantially too far away for near-mode operation. If this is the case, the shift implemented into the image in near-mode may impart a parallax offset into the imager, and it may be advantageous to return to far-mode operation to image this target.

FIG. 7 illustrates a process-flow diagram showing the switching of the imager from near-mode to far-mode imaging to reduce parallax offset. Here, a fixed focus, combination VL and IR camera (e.g., separate VL and IR optics) is operating 770 in near-mode and displaying at least portions of an IR image and an associated VL image of a target scene. The near-mode may be set as the default mode of operation. The near-mode may also have been previously selected by the user running a process similar to that outlined in FIG. 6. During operation, the user determines 772 if far-mode operation would be appropriate for the scene being imaged. This determination may once again be made on a number of factors, including but not limited to the distance between the target and the imager, any noticeable parallax offset between the VL and IR images, or a prompt provided by the processor based on a range finder measurement of distance to target. If far-mode operation is determined to not be appropriate for the scene at hand, the user may resume 774 operating the thermal imager in near-mode. However, if the user determines that far-mode is appropriate for the given scene, the user may instruct 776 the imager to switch to far-mode operation via the user interface. In embodiments employing a range finder, similar to those noted above, the mode switch may occur automatically based on the distance to target measurement and without a manual user input.

When the user instructs the imager to switch to far-mode, the processor receives 778 a signal from the user requesting disablement of near-mode operation. In doing so, the processor removes any shifts that were incorporated into the VL and/or IR images while in near-mode. This step may eliminate overcompensation of the near-mode shifting on a target that is too far away for the shifting to be effective. Finally, the imager displays 780 at least portions of the IR and VL images as detected by the imager, with no shift incorporated therein.

It should be appreciated that shifting images may be done in several ways. For example, a processor may simply adjust pixel locations of one image with respect to the other, causing one image to appear shifted while the other remains fixed. The processor may alternatively shift the pixel locations of one or more images with respect to a fixed coordinate system. Depending on the sizes and locations of the VL and IR images, when one is shifted with respect to the other, it is possible that in the resulting arrangement, neither the VL nor the IR image is completely contained within the extent of the other. In this case, the imager may ignore portions of the images that do not overlap in order to display a combination VL and IR image of the appropriate size. Alternatively, one of the VL and IR images may be displayed, and shifted, entirely within the other.

FIG. 8 shows an example combination VL and IR image with a parallax offset. In this example, IR image 804 is shown as being contained entirely within the VL image 806, and the parallax is such that the IR image 804 appears substantially below the VL image 806. For example, both the VL 806 and the IR 804 images show finger 888, though it is clear that there exists a parallax offset between the two images, as the finger 888 appears discontinuous. Accordingly, the camera may, in shifting from the mode of operation shown in FIG. 8 to the other mode, shift the VL image downward or shift the IR image upward in order to reduce the parallax offset. In some embodiments, the camera will shift the IR image entirely within the VL image boundary. In alternative embodiments, the camera may shift the VL image around the IR image to reduce an offset. More generally, if one of the VL and IR images is presented entirely within the boundary of the other, the camera may shift either the contained or containing image to reduce parallax offset between the two.

Although previously described processes involve steps of enabling or disabling near-mode operation, it is equivalent to implement a procedure involving the steps of enabling or disabling far-mode operation. In such a case, near-mode might be the default form of operation instead of far-mode. Such an embodiment may follow a process similar to those already described, wherein a user determines if the present mode of operation is appropriate for a given thermal scene. If so, then operation continues. If not, the user may select to disable the present mode of operation and/or enable an alternative mode. In yet further embodiments, there is no defined default mode of operation, as the camera may power on into whichever mode it was in prior to being previously powered off, or may additionally prompt the user to select a mode prior to operation. In certain embodiments, selection of the non-default mode (e.g., the near-mode) may start a timer, such as a timing function run by the processor. At the end of a predetermined or programmed amount of time, the processor may automatically switch modes back to the default mode (e.g., the far mode). All such embodiments are within the scope of this invention

Example thermal image cameras and related techniques have been described. The techniques described in this disclosure may also be embodied or encoded in a computer-readable medium, such as a non-transitory computer-readable storage medium containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), a hard disk, optical media, or other computer readable media.

Various examples have been described. These and other examples are within the scope of the following claims.

What is claimed:

1. A portable, hand-held thermal imaging camera comprising:
an infrared (IR) lens assembly having an associated IR sensor for detecting thermal images of a target scene;
a visible light (VL) lens assembly having an associated VL sensor for detecting VL images of the target scene;
a display adapted to display at least a portion of the VL image or at least a portion of the IR image;
a processor; and
a user interface; wherein
the camera comprises at least two modes of operation, selectable via the user interface, and wherein, when switched from one mode of operation to the other, the processor shifts at least one of the VL and IR images by a predetermined amount.

2. The thermal imaging camera of claim 1 wherein the camera is a fixed focus camera.

3. The thermal imaging camera of claim 1 wherein two of the at least two modes of operation comprise a near mode and a far mode.

4. The thermal imaging camera of claim 3 wherein far mode is the default mode of operation.

5. The thermal imaging camera of claim 3 wherein near mode is preferable with a distance-to-target of less than about six inches.

6. The thermal imaging camera of claim 1 wherein one of the VL and IR images is displayed and shifted within the other.

7. The thermal imaging camera of claim 1, wherein the predetermined shift is designated by a certain percentage of the size of one of the VL and IR images.

8. The thermal imaging camera of claim 1, wherein the selection via the user interface may be made by at least one of a push button, touch screen, switch, or voice command.

9. The thermal imaging camera of claim 1, further comprising a range finder for measuring the distance from the camera to the target scene.

10. The thermal imaging camera of claim 9, wherein the measured distance determines the amount of image shift.

11. The thermal imaging camera of claim 9, wherein the camera automatically selects the mode of operation based on the measured distance.

12. The thermal imaging camera of 9, wherein the camera prompts the user to change modes of operation based upon the distance- to-target measurement.

13. A method for reducing a parallax offset between visible light and infrared images in a thermal imaging camera, the method comprising:
providing a thermal imaging camera adapted to detect infrared and visible light images, and further adapted to display at least a portion of the VL image or at least a portion of the IR image; the camera further comprising a processor and a user interface;
detecting both IR and VL image data using the camera;
displaying portions of both the IR and VL image on a display;
observing, on the display, a parallax offset between the IR and VL images;
selecting, via the user interface, an alternate mode of operation of the thermal imaging camera, wherein:
the processor shifts at least one of the VL and IR images on the display by a predetermined amount in order to reduce the parallax offset.

14. The method of claim 13, wherein alternative modes of operation comprise a near-mode and a far-mode.

15. The method of claim 14 wherein near-mode operation is preferable with a distance-to-target of less than about six inches.

16. The method of claim 13, wherein one of the VL and IR images is displayed entirely within the other.

17. The method of claim 16, wherein the one of the VL and IR images that is displayed within the other is shifted within the other when switching between modes of operation.

18. The method of claim 1, wherein the predetermined amount of shift is designated by a percentage of the size of one of the VL and IR images.

19. The method of claim 1, wherein the selecting of an alternate mode of operation may be done by at least one of a push button, touch screen, switch, or voice command.
